(19) United States
(12) Patent Application Publication
(10) Pub. No.: US 2025/0121721 A1
(43) Pub. Date: Apr. 17, 2025

(54) RELATIVE POSITIONING METHOD BETWEEN AN ELECTRIC VEHICLE AND A CHARGING DEVICE, CHARGING APPARATUS AND CHARGING SYSTEM

(71) Applicant: DAZETECHNOLOGY S.R.L., Bergamo (IT)

(72) Inventors: Giacomo ZENONI, Bergamo (IT); Andrea DAMINELLI, Bergamo (IT)

(21) Appl. No.: 18/683,742

(22) PCT Filed: Aug. 17, 2022
(86) PCT No.: PCT/IB2022/057704

§ 371 Date: Feb. 14, 2024

(30) Foreign Application Priority Data
Aug. 20, 2021 (IT) 102021000022139

(51) Int. Cl. B60L 53/36; B60L 53/37; B60L 53/66

(52) U.S. Cl. CPC B60L 53/36; B60L 53/37; B60L 53/66

(57) ABSTRACT

A relative positioning method between an electrically or partially electrically powered vehicle and a charging device involves measuring, by a first measurement system, a first spatial distance value of a vehicle connector with respect to a device connector, and, depending on the first spatial distance value, moving the vehicle in a spatial distance reduction direction between the device connector and the vehicle connector. The relative positioning method further involves measuring by a second measurement system, different from the first measurement system, a second spatial distance value between the vehicle connector and the device connector, and, depending on the second spatial distance value, moving the device connector in the spatial distance reduction direction between the device connector and the vehicle connector, so that the vehicle connector is aligned with the device connector enabling mechanical coupling between the vehicle connector and the device connector to start charging.

The present invention relates to a relative positioning method between an electrically or partially electrically powered vehicle and a charging device suitable for being connected to a vehicle connector arranged below the vehicle.

Furthermore, the present invention also relates to a charging apparatus and a charging system suitable for carrying out the steps of the method of the present invention.

The context in which the present invention finds specific application is the field of charging electrically powered or hybrid powered vehicles.

In particular, the context within which the present invention falls relates to the charging of the battery pack of said vehicles by connecting the charging connector below the vehicle, i.e. so-called ACDU systems, i.e. Automatic Connection Device Underbody. Therefore, the present invention is not instead directed to so-called ACDS charging systems, i.e. Automatic Connection Device Side, which instead require the side connection on the vehicle side for charging.

Systems for charging vehicles by manual connection of electric charging connectors are known in the art.

Automated connection systems are also known in the art. An example of such systems is described in the prior art document WO2018055498A1, which describes an automated ACDU charging device.

However, the charging systems of the prior art do not solve the drawback of how to align the connector on the vehicle with the connector on the charging device for mutual coupling in a simple and effective manner, both in semi-autonomous mode and in completely autonomous mode.

One of the objects of the present invention is that of solving the aforementioned drawback relating to the prior art.

The aforesaid object is achieved with a relative positioning method between an electrically or partially electrically powered vehicle and a charging device, a charging apparatus and a charging system in accordance with the appended independent claims. The dependent claims describe further preferred embodiments.

The features and advantages of the method, of the apparatus and of the system according to the present invention will be from the following apparent description, made by way of an indicative and non-limiting example, with reference to the accompanying figures, in which:

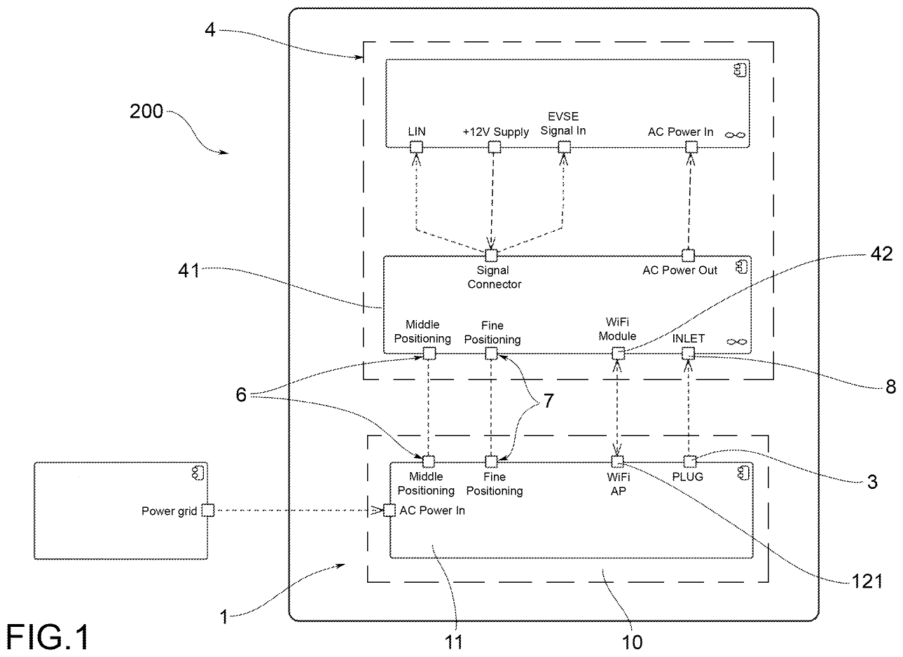

FIG. 1 shows a block diagram of a charging system according to an embodiment of the present invention;

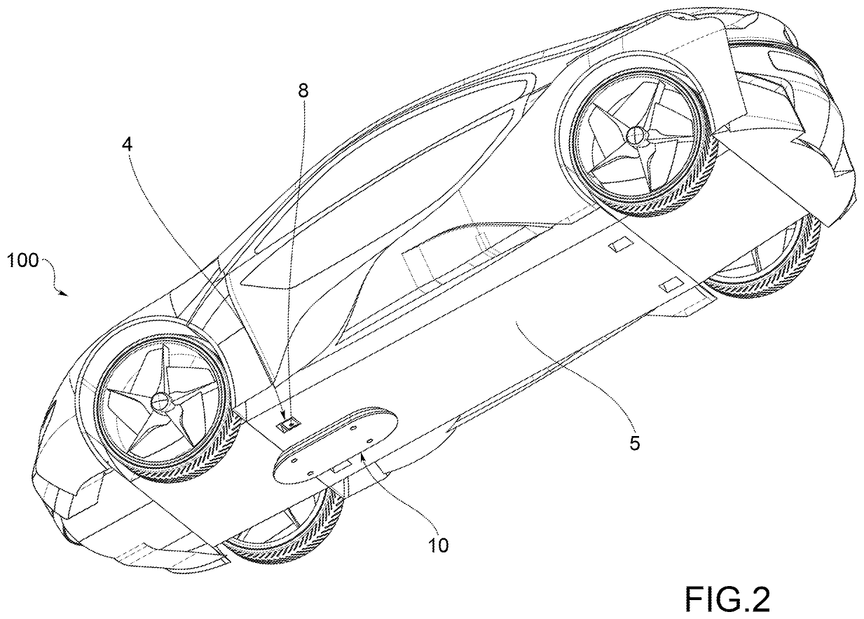

FIG. 2 shows a vehicle and a charging device arranged below the vehicle according to an embodiment of the present invention;

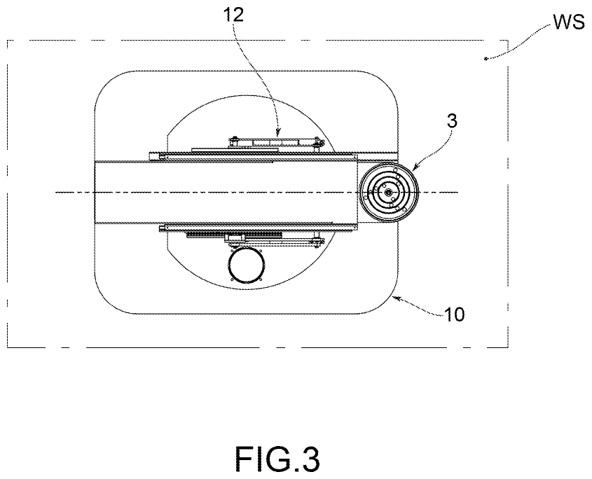

FIG. 3 shows a top plan view of a charging device according to an embodiment of the present invention;

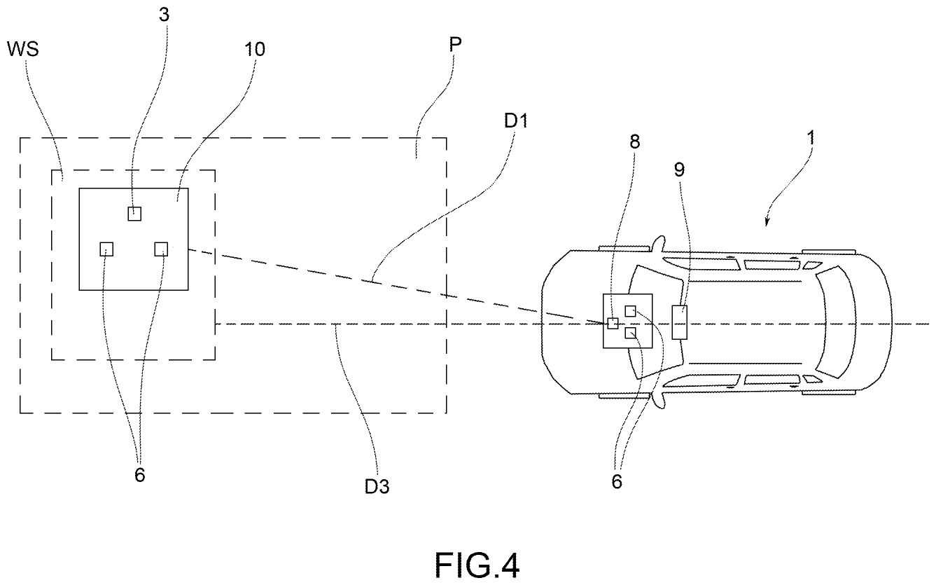

FIG. 4 shows a top plan view of the charging system according to an embodiment of the present invention and in particular it shows a mutual position between a vehicle and the charging device in a step of the method according to an embodiment of the present invention;

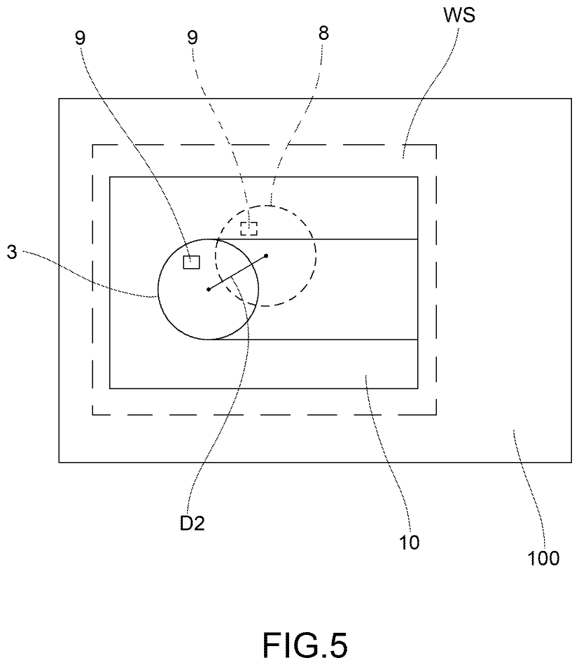

FIG. 5 shows a top plan view of a schematic detail of the charging system according to an embodiment of the present invention and in particular it shows a mutual position between a vehicle and the charging device in a step of the fine positioning method, according to an embodiment of the present invention.

According to the accompanying figures, a charging system, which is the subject per se of the present invention, is collectively referred to by reference numeral 200.

The charging system 200 comprises an apparatus for charging a vehicle 100, with this latter also being the subject, per se, of the present invention and described in the continuation of the present description.

In addition to the charging apparatus 1, the charging system 200 comprises an electrically or partially electrically powered vehicle 100, for example an electric car or an electric truck, comprising a vehicle charging unit 4 comprising an electronic processing unit 41 of the vehicle, for example an electronic board provided with a processor, and the vehicle connector 8, suitable for receiving the electric power for charging the battery pack present on the electric vehicle.

The charging apparatus 1 comprises a charging device 10 positioned in a device working space WS and having a smaller working area than the parking area P of the vehicle. In other words, the working area WS is contained in the parking area P. Preferably, the charging device 10 is a robotic device suitable for moving its own charging device connector 3 in an automated manner in the three directions of the space, for example by means of an articulated system. For example, the charging device 3 is a device having the technical features described in document WO2018055498A1 on behalf of the same applicant of this patent application, which is to be considered incorporated herein by reference. As mentioned, the charging device 10 comprises a device connector 3 and also an electronic processing unit 11 of the device and automated movement means 12 adapted to move the device connector 3 into the working space WS in the three dimensions of the space for reaching the vehicle connector 8 for coupling for charging.

The charging apparatus 1 also comprises a first measurement system 6, configured to detect a first spatial distance value D1 between the device connector 3 and the vehicle connector 8 on the vehicle 100 and send such first spatial distance value D1 towards the electronic processing unit 41 of the vehicle housed on the vehicle. The first measurement system 6, together with the vehicle electronic processing unit 41 of the vehicle, forms a middle positioning system, i.e. with an intermediate positioning accuracy between the vehicle connector 8 and the device connector 3 (for example with a maximum uncertainty of a few centimeters).

The charging apparatus 1 also comprises a second measurement system 7, different from the first measurement system 6 and configured to detect a second spatial distance value D2 between the device connector 3 and the vehicle connector 8 and receive said second spatial distance value D2 on the electronic processing unit 11 of the device. The second measurement system 7, together with the electronic processing unit 11 of the device, forms a fine positioning system, i.e. with a very fine positioning accuracy between the vehicle connector 8 and the device connector 3, for example with a maximum uncertainty of a few millimeters.

In the apparatus 1, the electronic processing unit 11 of the device is configured to calculate a movement trajectory for the device connector 3 to obtain a spatial distance reduction between the device connector 3 and the vehicle connector 8. Furthermore, the electronic processing unit 11 of the device is configured to calculate control signals for the automated movement means 12 so that the device connector 3 is moved to achieve an alignment with the vehicle connector 8 with an accuracy that is such to enable the mechanical coupling between the vehicle connector 8 and the device connector 3 to start charging.

According to an embodiment, the first measurement system 6 is a position measurement system based on ultrasound technology, or electromagnetic technology or technology using video cameras, or preferably and advantageously on ultra wide band (UWB) technology, for example in the 6-9 GHz range.

According to an embodiment, the second measurement system 7 is a position measurement system based on ultrasound technology or, preferably and advantageously, based on infrared technology. Preferably, it is a system comprising an infrared light emitting source, for example an LED, and an infrared light detection sensor, for example a photodiode, wherein one of the LED or the photodiode are mounted on the device connector 3 and the other one is mounted on the vehicle connector 8.

According to an embodiment, the electronic processing unit 41 of the vehicle is configured to:
receive the first spatial distance value D1;
calculate as a function of the first spatial distance value D1 a vehicle movement trajectory for reducing the spatial distance between the device connector 3 and the vehicle connector 8.

According to an embodiment variant, the electronic processing unit 41 of the vehicle is further configured to send control signals to a power system of the vehicle and to a steering system of the vehicle for moving the vehicle independently along the vehicle movement trajectory calculated.

According to an embodiment variant, the electronic processing unit 41 of the vehicle is further configured to send a visual feedback signal to a display inside the vehicle 100 as a function of the first measured spatial distance value D1, so as to guide the driver of the vehicle towards a correct positioning between the vehicle connector 8 and the device connector 3 within the working space WS of the charging device 10.

In particular, during the movement step of the vehicle, the first spatial distance value D1 is constantly and repeatedly measured and sent to the electronic processing unit 41 of the vehicle so that the electronic processing unit 41 of the vehicle constantly processes and sends a visual feedback signal to a display inside the vehicle 100 for the driver during the entire parking step of the vehicle. Therefore, the driver of the vehicle is able to see the continuously updated relative position between the charging device 10 and the vehicle connector 8 on the internal display.

A subject of the present invention is also a relative positioning method between an electrically or partially electrically powered vehicle 100 and a charging device 10 suitable for being connected to a vehicle connector 8 arranged below the vehicle 100, preferably on the lower flat bed 5 of the vehicle for electrically charging a battery of the vehicle.

Preferably, the method according to the present invention is carried out by means of a charging apparatus 1 or a charging system 200 described in the present description.

The method according to the present invention comprises the following operating steps:
a) providing the charging device 10 positioned in a device working space WS having a smaller working area than the parking area P of the vehicle and contained in said parking area P;
b) providing the vehicle 100 comprising a vehicle charging unit 4 comprising an electronic processing unit 41 of the vehicle and the vehicle connector 8;
c) measuring, by means of a first measurement system 6, a first spatial distance value D1 of the vehicle connector 8 with respect to the device connector 3 in the device working space WS and receiving said first spatial distance value D1 on the electronic processing unit 41 of the vehicle;
d) as a function of the first spatial distance value D1, moving the vehicle 100 in a spatial distance reduction direction between the device connector 3 and the vehicle connector 8 until reaching a first predetermined threshold distance value and so that the vehicle connector is inside the device working space WS and above the charging device 10 (middle positioning);
e) measuring, by means of a second measurement system 7, different from the first measurement system 6 and preferably more accurate, a second spatial distance value D2 between the vehicle connector 8 and the device connector 3 and receiving said second spatial distance value D2 on the electronic processing unit 11 of the device;
f) as a function of the second spatial distance value D2, moving the device connector 3 through the automated movement means 12 in a spatial distance reduction direction between the device connector 3 and the vehicle connector 8 until reaching a second predetermined threshold distance value between the two connectors, which is less than the first predetermined threshold distance value, and so that the vehicle connector 8 is aligned with the device connector 3 with an accuracy that is such to enable the mechanical coupling between the vehicle connector 8 and the device connector 3 to start charging (fine positioning).

According to an embodiment variant of the method, prior to step c), the method provides the following optional operating steps:
b1) measuring, preferably by means of a third measurement system 9, for example a video camera, a rough spatial distance value D3 between the vehicle connector 8 and the charging device 10 and receiving said rough spatial distance value D3 on the electronic processing unit 41 of the vehicle;
b2) as a function of the rough spatial distance value D3, moving the vehicle 100 in a spatial distance reduction direction between the charging device 10 and the vehicle connector 8 until reaching a third predetermined threshold distance value which is greater than the first predetermined threshold distance value and the second predetermined threshold distance value, and so that the vehicle 100 is above the charging device 10, without the wheels of the vehicle being above the charging device 10 and without the vehicle connector 8 being necessarily positioned inside the device working space WS (coarse positioning).

According to an embodiment, the charging device 10 comprises a device wireless data communication module 121 and the charging unit 4 comprises a vehicle wireless data communication module 42 (for example Wi-Fi communication modules, wherein one of the two modules is the access point and the other is the client). Data relating to the state of the charging device 10 (free, busy, fault, errors, safety) are preferably exchanged between the charging device 10 and the charging unit 4.

According to an embodiment, in step c), prior to the activation of the first measurement 6, a wireless data exchange communication is established between the device wireless data communication module 121 and the vehicle wireless data communication module 42 for communicating the measured position data.

Preferably, the activation of the first measurement system 6 for measuring the first spatial distance value D1 takes place when the spatial distance between the charging device 10 and the vehicle connector 8 is greater than about two meters, preferably greater than four meters.

According to an embodiment, therefore, the charging system 200 also comprises a third measurement system 9, which is preferably based on video image processing technology acquired by means of a video camera, and which preferably has a measurement accuracy with greater uncertainty than the first 6 and the second measurement system 7.

As regards the second measurement system 7, when it is implemented with infrared-based technology, the alignment between the device connector 3 and the vehicle connector 8 takes place by means of a step of the method in which the device connector 3 is moved by the automated movement means 12 (for example a robotic arm) by means of an iterative process of searching for the point of maximum intensity of the infrared signal emitted by the infrared emitter and detected by the infrared receiver.

Innovatively, the charging apparatus, the charging system and the method according to the present invention allow the achievement of the predetermined objects, that is aligning the connector on the vehicle with the connector on the charging device for mutual coupling in a simple and effective manner, both in semi-autonomous mode and in completely autonomous mode.

Furthermore, in an innovative manner, the present invention allows an excellent compromise between consumption minimization and performance guarantee to be achieved.

Advantageously, moreover, the present method also allows the retrofitting of already existing electric vehicles.

It is clear that a person skilled in the art may make changes to the invention described above in order to meet contingent needs, which changes all fall within the scope of protection as defined in the following claims.

What is claimed is:

1. A relative positioning method between an electrically or partially electrically powered vehicle and a charging device suitable for being connected to a vehicle connector arranged below the vehicle for electrically charging a battery of the vehicle, comprising the following operating steps:
a) providing the charging device positioned in a device working space having a smaller working area than a parking area of the vehicle and contained in said parking area, said charging device comprising a device connector, an electronic processing unit, and automated movement means adapted to move the device connector towards the vehicle connector for receiving as a coupling the device connector for charging;
b) providing the vehicle comprising a vehicle charging unit comprising an electronic processing unit of the vehicle and the vehicle connector;
c) measuring, by a first measurement system, a first spatial distance value of the vehicle connector with respect to the device connector in the device working space and receiving said first spatial distance value on the electronic processing unit of the vehicle;
d) as a function of the first spatial distance value, moving the vehicle in a spatial distance reduction direction between the device connector and the vehicle connector until reaching a first predetermined threshold distance value so that the vehicle connector is inside the device working space and above the charging device;
e) measuring, by a second measurement system, different from the first measurement system, a second spatial distance value between the vehicle connector and the device connector and receiving said second spatial distance value on the electronic processing unit of the charging device; and
f) as a function of the second spatial distance value, moving the device connector through the automated movement means in the spatial distance reduction direction between the device connector and the vehicle connector until reaching a second predetermined threshold distance value, which is less than the first predetermined threshold distance value, so that the vehicle connector is aligned with the device connector with an accuracy such as to enable mechanical coupling between the vehicle connector and the device connector to start charging.

2. The relative positioning method of claim 1, wherein prior to step c) the method comprises the following operating steps:
b1) measuring, by a third measurement system, a rough spatial distance value between the vehicle connector and the charging device and receiving said rough spatial distance value on the electronic processing unit of the vehicle; and
b2) as a function of the rough spatial distance value, moving the vehicle in a spatial distance reduction direction between the charging device and the vehicle connector until reaching a third predetermined threshold distance value greater than the first predetermined threshold distance value and the second predetermined threshold distance value, so that the vehicle is above the charging device, without wheels of the vehicle being above the charging device and without the vehicle connector being necessarily positioned inside the device working space.

3. The relative positioning method of claim 1, wherein the charging device further comprises a device wireless data communication module and the vehicle charging unit further comprises a vehicle wireless data communication module, and wherein in step c), prior to an activation of the first measurement system, a wireless data exchange communication is established between the device wireless data communication module and the vehicle wireless data communication module.

4. The relative positioning method of claim 3, wherein the activation of the first measurement system for measuring the first spatial distance value takes place when a spatial distance between the charging device and the vehicle connector is greater than about two meters.

5. The relative positioning method of claim 1, wherein the first measurement system is a measurement system based on ultra wide band (UWB) technology.

6. The relative positioning method of claim 1, wherein the second measurement system is based on infrared technology.

7. The relative positioning method of claim 2, wherein the third measurement system is based on a technology for processing video images acquired by a video camera.

8. A charging apparatus for charging an electrically or partially electrically powered vehicle, suitable for carrying out the steps of the relative positioning method of claim 1, said charging apparatus comprising:
a charging device positioned in a device working space having a smaller working area than a parking area of the vehicle and contained in said parking area, said charging device comprising a device connector, an electronic processing unit, and automated movement means adapted to move the device connector in the device working space in three spatial dimensions to reach a vehicle connector to be coupled for charging;
a first measurement system, configured to detect a first spatial distance value between the device connector and the vehicle connector on the vehicle and send said first spatial distance value towards an electronic processing unit of the vehicle housed on the vehicle; and
a second measurement system, different from the first measurement system, configured to detect a second spatial distance value between the device connector and the vehicle connector and receive said second spatial distance value on the electronic processing unit of the charging device;
wherein said electronic processing unit of the charging device is configured to calculate a movement trajectory for the device connector to obtain a spatial distance reduction between the device connector and the vehicle connector,
and wherein said electronic processing unit of the charging device is configured to calculate control signals for the automated movement means so that the device connector is moved to achieve an alignment with the vehicle connector with an accuracy such as to enable mechanical coupling between the vehicle connector and the device connector to start charging.

9. A charging system for charging an electrically or partially electrically powered vehicle and carrying out the steps of the relative positioning method of claim 1, said charging system comprising a charging apparatus comprising:
a charging device positioned in a device working space having a smaller working area than a parking area of the vehicle and contained in said parking area, said charging device comprising a device connector, an electronic processing unit, and automated movement means adapted to move the device connector in the device working space in three spatial dimensions to reach a vehicle connector to be coupled for charging;
a first measurement system, configured to detect a first spatial distance value between the device connector and the vehicle connector on the vehicle and send said first spatial distance value towards an electronic processing unit of the vehicle housed on the vehicle; and
a second measurement system, different from the first measurement system, configured to detect a second spatial distance value between the device connector and the vehicle connector and receive said second spatial distance value on the electronic processing unit of the charging device;
wherein said electronic processing unit of the charging device is configured to calculate a movement trajectory for the device connector to obtain a spatial distance reduction between the device connector and the vehicle connector,
and wherein said electronic processing unit of the charging device is configured to calculate control signals for the automated movement means so that the device connector is moved to achieve an alignment with the vehicle connector with an accuracy such as to enable mechanical coupling between the vehicle connector and the device connector to start charging,
and a vehicle comprising a vehicle charging unit comprising an electronic processing unit of the vehicle and the vehicle connector;
wherein the electronic processing unit of the vehicle is configured to:
receive the first spatial distance value; and
calculate as a function of the first spatial distance value a vehicle movement trajectory for reducing a spatial distance between the device connector and the vehicle connector.

10. The charging system of claim 9, wherein the electronic processing unit of the vehicle is further configured to send control signals to a power system of the vehicle and to a steering system of the vehicle for moving the vehicle independently along the calculated vehicle movement trajectory.

11. The charging system of claim 9, wherein the electronic processing unit of the vehicle is further configured to send a visual feedback signal to a display inside the vehicle as a function of the first spatial distance value measured.

12. The relative positioning method of claim 1, wherein the vehicle connector is arranged on a lower flat bed of the vehicle.

13. The relative positioning method of claim 3, wherein the activation of the first measurement system for measuring the first spatial distance value takes place when a spatial distance between the charging device and the vehicle connector is greater than four meters.

14. The relative positioning method of claim 6, wherein the second measurement system is based on a system comprising an infrared light emitting source and an infrared light detecting sensor.

15. The relative positioning method of claim 14, wherein the infrared light emitting source is an LED and the infrared light detecting sensor is a photodiode.
